(19) United States
(12) Patent Application Publication
(10) Pub. No.: US 2010/0239001 A1
(43) Pub. Date: Sep. 23, 2010

(54) VIDEO STREAMING SYSTEM, TRANSCODING DEVICE, AND VIDEO STREAMING METHOD

(76) Inventors: Kazuteru Watanabe, Tokyo (JP); Kazunori Ozawa, Tokyo (JP)

Correspondence Address: Mr. Jackson Chen, 6535 N. STATE HWY 161, IRVING, TX, 75039, US

(21) Appl. No.: 12/600,053

(22) PCT Filed: Apr. 24, 2008
(86) PCT No.: PCT/JP2008/057916

§ 371 Date: Nov. 13, 2009

(30) Foreign Application Priority Data
May 23, 2007 (JP) 2007-136449

(51) Int. Cl. H04N 7/26

(52) U.S. Cl. 375/240.12; 375/240.01; 375/E07.243

(57) ABSTRACT

A video streaming system includes a streaming server (101) which stores video streams and a transcoding device (102) which receives the video stream desired by a terminal (103), and analyzes the video stream to transcode only a video stream which falls within a range in which transcoding is required, when transmitting the video stream to the terminal (103) upon transcoding it into a video stream which can be transmitted from an arbitrary position designated by the terminal (103). The transcoding device (102) generates a playback start frame by a video transcoder (108) when the video stream reaches a playback start position, and analyzes subsequent frames by using the video transcoder (108). The transcoding device transcodes a video stream only when transcoding is required, while outputting a video stream without any change when transcoding is not required.

### TECHNICAL FIELD

The present invention relates to a technique of streaming videos and, more particularly, to a video streaming system, transcoding device, and video streaming method which transmit a compressed/encoded video bit stream stored in a streaming server upon transcoding it at a high speed with high quality so as to allow playback from an arbitrary position.

### BACKGROUND ART

The following have recently been known as video compressing/encoding schemes for efficiently transmitting video signals at a low bit rate: ITU-T (International Telecommunication Union Telecommunication Standardization Sector) recommendations H.261 and H.263 and MPEG (Moving Picture Experts Group)-4 internationally standardized by ISO (International Organization for Standardization)/IEC (International Electrotechnical Commission). H.264/MPEG-4 AVC (Advanced Video Coding) internationally standardized by ITU-T and ISO/IEC has attracted attention because it can transmit video signals more efficiently than the above video compressing/encoding scheme.

The video compressing/encoding scheme includes intra prediction for encoding by using only the image data of a current frame and inter prediction for encoding by referring to the images of past and future frames.

In intra prediction, an input video frame is encoded by performing DCT (Discrete Cosine Transform) on a so-called macroblock basis and then performing variable-length encoding of DCT coefficients. Alternatively, intra prediction is performed for each macroblock or for each block obtained by further dividing a macroblock such that prediction is performed by using the pixels of an adjacent block such as a left or upper block, DCT or DIT (Discrete Integer Transform) is then performed for a prediction residual signal, and a DCT coefficient or a DIT coefficient is variable-length encoded.

In inter prediction, when an input video frame is to be encoded, a prediction residual signal is obtained by performing motion compensation prediction between decoded pixels of the input frame and of a past or future frame, DCT or DIT is performed for the prediction residual signal, and a motion vector, a DCT coefficient, or the like is variable-length encoded.

When a video is to be streamed from a streaming server to a terminal, the image of a preceding frame cannot be referred to for a playback start frame at the time of playback. For this reason, a playback start frame always needs to be an intra frame encoded by only intra prediction. If a playback start frame is not an intra frame, a decoded image is disturbed.

According to H.264, inter prediction is performed by referring to a plurality of frames. If, therefore, there is an inter frame obtained by inter prediction upon referring to a frame preceding a playback start frame, transmitting the inter frame without any change will disturb a decoded image.

In addition, H.264 allows inter prediction (Long Term prediction) by referring to not only the latest frame but also a specific frame by storing it in a reference frame buffer for a long term. For this reason, if an inter frame obtained by Long Term prediction has referred to the image of a frame preceding the playback start frame, playing back the image without any change will also disturb the decoded image.

Conventionally, when an image is to be played back from an arbitrary frame of encoded data, the input encoded data is temporarily decoded, and re-encoded from the playback start frame to generate playback encoded data (see, for example, Japanese Patent Laid-Open Nos. 9-219838 and 2003-333528).

As another method, a video can be streamed from the position of an intra frame in an original video stream. However, the playback start position is influenced by the insertion cycle of intra frames of a video stream, and hence it is difficult to stream a video from a desired position.

### DISCLOSURE OF INVENTION

### Problem to be Solved by the Invention

The first problem is that when the encoded data of an image to be streamed is generated, re-encoding degrades the image quality of a playback image. This is because when each video data is temporarily decoded, a quantization error is generated. In addition, since re-encoding is performed by using a decoded image having a quantization error as compared with the original image, re-quantization enlarges the error.

The second problem is that when the encoded data of an image to be streamed is generated, re-encoding increases the processing load on the apparatus, resulting in the prolongation of the time for transcoding. This is because since the encoded data of an image to be streamed is generated by re-encoding, decoding processing and encoding processing are required.

The present invention has been made to solve the above problems, and has as its object to provide a video streaming system, transcoding device, and video streaming method which can transcode a video stream desired by a terminal into a high-quality video stream and transmit it from a desired frame to the terminal when transmitting the video stream from an arbitrary position designated by the terminal.

### Means of Solution to the Problem

A video streaming system according to the present invention is characterized by comprising a streaming server that stores a video stream, and a transcoding device that transmits, to a terminal via a network, a video stream received from the streaming server upon transcoding the video stream into a video stream that is configured to be transmitted from an arbitrary position designated by the terminal, the transcoding device comprising means for receiving a video stream desired by the terminal from the streaming server, and analyzing the video stream to covert only a portion of the video stream that falls within a range in which transcoding is required, when transmitting the video stream to the terminal upon transcoding the video stream into a video stream that is configured to be transmitted from an arbitrary position designated by the terminal.

In addition, a transcoding device according to the present invention is characterized by comprising means for receiving a video stream desired by a terminal from a streaming server, and means for analyzing a received video stream to covert only a portion of the video stream that falls within a range in which transcoding is required, when transmitting the video stream upon transcoding the video stream into a video stream that is configured to be transmitted from an arbitrary position designated by the terminal.

Furthermore, a video streaming method according to the present invention is characterized by comprising the reception step of receiving a video stream desired by a terminal from a streaming server that stores a video stream, and the transcoding step of transmitting, to the terminal via a network, a video stream received from the streaming server upon transcoding the video stream into a video stream that is configured to be transmitted from an arbitrary position designated by the terminal, the transcoding step including the step of analyzing the video stream received from the streaming server to covert only a portion of the video stream that falls within a range in which transcoding is required, when transmitting the video stream upon transcoding the video stream into a video stream that is configured to be transmitted from an arbitrary position designated by the terminal.

### Effects of the Invention

The first effect of the present invention is that when a video stream desired by a terminal is to be transmitted from an arbitrary position designated by the terminal, the video stream can be transmitted to the terminal upon transcoding it into a high-quality video stream.

The second effect of the present invention is that when a video stream desired by a terminal is to be transmitted from an arbitrary position designated by the terminal, the video stream can be transmitted to the terminal upon transcoding it at a high speed.

The third effect of the present invention is that when a video stream desired by a terminal is to be transmitted from an arbitrary position designated by the terminal, the video stream can be transmitted to the terminal from a desired frame.

### BRIEF DESCRIPTION OF DRAWINGS

FIG. 1 is a flowchart showing the operation of a video streaming system of the present invention;

FIG. 2 is a block diagram showing the arrangement of a video streaming system according to the first exemplary embodiment of the present invention;

FIG. 3 is a block diagram showing the arrangement of a streaming server in the video streaming system in FIG. 2;

FIG. 4 is a block diagram showing the arrangement of a control information analysis unit in the video streaming system in FIG. 2;

FIG. 5 is a block diagram showing the arrangement of a video transcoder in the video streaming system in FIG. 2;

FIG. 6 is a block diagram showing the arrangement of an encoding unit in the video transcoder in FIG. 5;

FIG. 7 is a block diagram showing the arrangement of a video streaming system according to the second exemplary embodiment of the present invention;

FIG. 8 is a block diagram showing the arrangement of a control information analysis unit in the video streaming system in FIG. 7;

FIG. 9 is a block diagram showing the arrangement of a video streaming system according to the third exemplary embodiment of the present invention;

FIG. 10 is a block diagram showing the arrangement of a control information analysis unit in the video streaming system in FIG. 9;

FIG. 11 is a block diagram showing the arrangement of a video streaming system according to the fourth exemplary embodiment of the present invention;

FIG. 12 is a block diagram showing the arrangement of a control information analysis unit in the video streaming system in FIG. 11;

FIG. 13 is a block diagram showing the arrangement of a video streaming system according to the fifth exemplary embodiment of the present invention;

FIG. 14 is a block diagram showing the arrangement of a control information analysis unit in the video streaming system in FIG. 13;

FIG. 15 is a block diagram showing the arrangement of a video streaming system according to the sixth exemplary embodiment of the present invention;

FIG. 16 is a block diagram showing the arrangement of a control information analysis unit in the video streaming system in FIG. 15;

FIG. 17 is a block diagram showing the arrangement of the video transcoder of a video streaming system according to the seventh exemplary embodiment of the present invention;

FIG. 18 is a block diagram showing the arrangement of a stream transcoding unit in the video transcoder in FIG. 17; and

FIG. 19 is a block diagram showing the arrangement of a video streaming system according to the eighth exemplary embodiment of the present invention.

### BEST MODE FOR CARRYING OUT THE INVENTION

### First Exemplary Embodiment

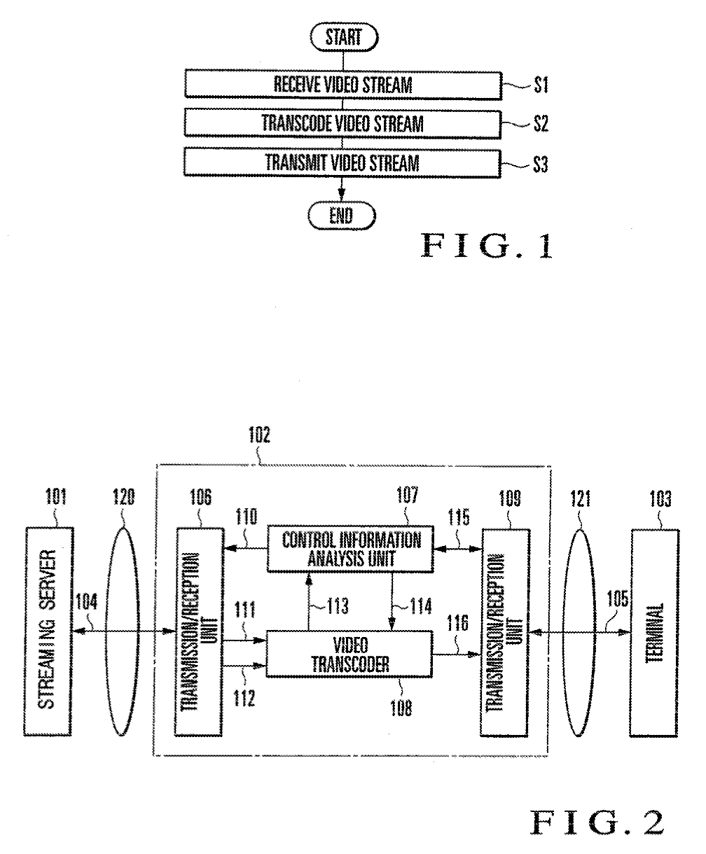

FIG. 1 shows the operation of a video streaming system of the present invention. The video streaming system of the present invention receives a video stream desired by a terminal and the information of a playback start position (step S1 in FIG. 1). This system transcodes a video stream transmitted by a streaming server into a video stream that can be played back from a playback start position (step S2), and transmits it to the terminal (step S3). With regard to frames after the playback start position, the system analyzes an input video stream and transcodes only encoded data required to be transcoded on the basis of the analysis result. With regard to encoded data which is not required to be transcoded, the system outputs input data without any change.

An exemplary embodiment of the present invention will be described in detail below with reference to the accompanying drawings. FIG. 2 shows the arrangement of a video streaming system according to the first exemplary embodiment of the present invention. The video streaming system comprises a streaming server 101 which transmits a compressed/encoded video bit stream (to be referred to as a video stream hereinafter), a transcoding device 102 which transcodes the video stream received from the streaming server 101 into a video stream which can be played back from the playback start position designated by a terminal 103, a transmission path 104 which connects the streaming server 101 to the transcoding device 102, and a transmission path 105 which connects the transcoding device 102 to the terminal 103. As shown in FIG. 2, reference numeral 120 denotes a network which connects the streaming server 101 to the transcoding device 102; and 121, a network which connects the transcoding device 102 to the terminal 103.

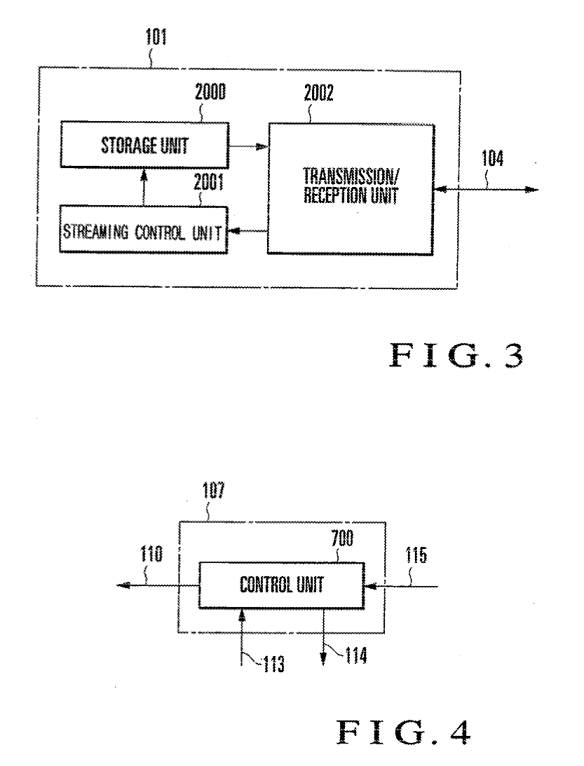

The streaming server 101 stores video streams. FIG. 3 shows the arrangement of the streaming server 101. The streaming server 101 includes a storage unit 2000 which stores video streams, a streaming control unit 2001 which controls the overall streaming server, and a transmission/reception unit 2002 which exchanges information with the transcoding device 102.

Upon receiving video stream designation information from the transcoding device 102 via the transmission/reception unit 2002, the streaming control unit 2001 of the streaming server 101 extracts the performance information (decoding information) of the designated video stream and the designated video stream from the storage unit 2000, and transmits them to the transmission/reception unit 2002.

The transmission/reception unit 2002 transmits the decoding information of this video stream and the video stream to the transcoding device 102 via the transmission path 104. Decoding information is, for example, DCI (Decoder Configuration Information), SPS (Sequence Parameter Set), or PPS (Picture Parameter Set).

The transcoding device 102 includes a transmission/reception unit 106 which receives a video stream 112 transmitted from the streaming server 101 and decoding information 111 of the video stream 112, a control information analysis unit 107 which specifies a video stream desired by the terminal 103 and the playback start position of the video stream, a video transcoder 108 which transcodes the video stream 112 received from the streaming server 101 into a video stream which can be transmitted from the playback start position, and a transmission/reception unit 109 which transmits, to the terminal 103, video stream selection information 115 to be exchanged between the terminal 103 and the control information analysis unit 107 and a video stream 116 output from the video transcoder 108.

The transmission/reception unit 106 transmits video stream designation information 110, which the control information analysis unit 107 has transmitted, to the streaming server 101 via the transmission path 104. The video stream designation information 110 is, for example, the name or list number of a video stream in the streaming server 101, a telephone number, or URL (Uniform Resource Locators).

The transmission/reception unit 106 transmits the video stream 112 received from the streaming server 101 and the decoding information 111 of the video stream 112 to the video transcoder 108.

FIG. 4 shows the arrangement of the control information analysis unit 107. The control information analysis unit 107 comprises a control unit 700. The control unit 700 forms a playback start position specifying unit. The control information analysis unit 107 analyzes the video stream selection information 115 of the terminal 103 which is received from the transmission/reception unit 109, and specifies the video stream desired by the terminal 103 and the playback start position of the video stream. Information which specifies the video stream desired by the terminal 103 is, for example, the name or list number of the video stream, a telephone number, or URL. Information which specifies the playback start position of a video stream is, for example, time information from the head of the stream, a frame number, or a track number obtained by dividing the stream by a predetermined time.

The control information analysis unit 107 generates the video stream designation information 110 which requests the streaming server 101 to transmit the video stream desired by the terminal 103, and transmits the video stream designation information 110 to the transmission/reception unit 106. The control information analysis unit 107 notifies the video transcoder 108 of playback start position information 114 of the video stream received from the streaming server 101. The playback start position information 114 notified by the control information analysis unit 107 to the video transcoder 108 is, for example, time information from the head of a stream or a frame number.

In addition, upon receiving a playback end request from the terminal 103, the control information analysis unit 107 extracts playback end position information 113 from the video transcoder 108 and transmits it to the transmission/reception unit 109. The playback end position information 113 is, for example, time information from the head of a stream, a frame number, or a track number obtained by dividing the stream by a predetermined time.

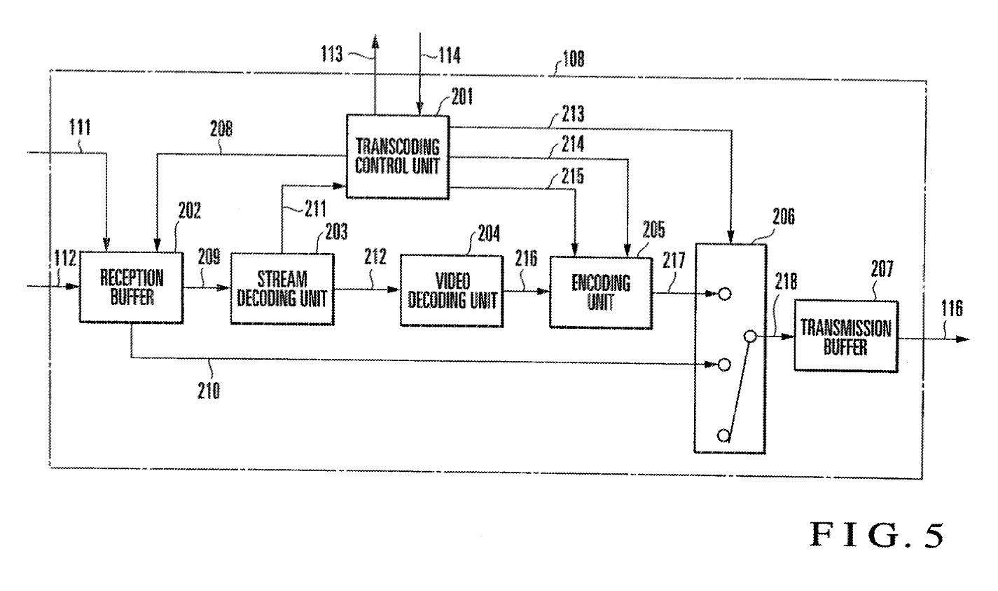

The video transcoder 108 will be described next in detail with reference to FIG. 5. FIG. 5 shows the detailed arrangement of the video transcoder 108 in FIG. 2.

The video transcoder 108 comprises a transcoding control unit 201, a reception buffer 202, a stream decoding unit 203, a video decoding unit 204, an encoding unit 205, a switch 206, and a transmission buffer 207. The reception buffer 202, stream decoding unit 203, video decoding unit 204, encoding unit 205, and switch 206 constitute a playback start frame generating unit and a video stream transcoding unit. The reception buffer 202 and the switch 206 constitute a feed-through output unit which outputs a video stream without any change.

The reception buffer 202 receives the decoding information 111 and video stream 112 transmitted from the transmission/reception unit 106 and transmits them to the stream decoding unit 203. The reception buffer 202 has a function of detecting a break for each frame or slice at the video stream 112. Upon receiving a transmission request 208 to output a stream to the switch 206 from the transcoding control unit 201, the reception buffer 202 divides the video stream 112 on a frame basis or a slice basis and transmits it as a video stream 210 to the switch 206. The reception buffer 202 detects a break for each frame or slice of the video stream 112 on the basis of a unique bit string such as a start code.

The stream decoding unit 203 decodes a video stream 209 received from the reception buffer 202, and transcodes the stream into parameters. The stream decoding unit 203 then notifies the transcoding control unit 201 of information 211 of some of the transcoded parameters. The stream decoding unit 203 notifies the video decoding unit 204 of all transcoded parameter information 212.

The video decoding unit 204 decodes image data 216 from the parameter information 212 received from the stream decoding unit 203, and transmits the resultant data to the encoding unit 205.

The transcoding control unit 201 stores the playback start position information 114 of the stream notified from the control information analysis unit 107 as information indicating the transcoding start position of the stream.

The transcoding control unit 201 analyzes the information 211 of the stream received from the stream decoding unit 203 and determines whether the video stream 209 received by the stream decoding unit 203 has reached the transcoding start position. Upon determining that the video stream 209 has reached the transcoding start position, the transcoding control unit 201 transmits a decoded image data capture request 215 to the encoding unit 205 to generate a playback start frame from the latest decoded image data 216 generated by the video decoding unit 204.

Upon determining that the video stream 209 has reached the transcoding start position, the transcoding control unit 201 notifies the encoding unit 205 of transcoding parameter information 214 required to generate a playback start frame. Of the transcoding parameter information 214, information required to generate a playback start frame is, for example, decoding information or a frame type (intra-frame prediction frame). Upon determining that the video stream 209 has reached the transcoding start position, the transcoding control unit 201 transmits a switching request 213 to the switch 206 to connect the output of the encoding unit 205 to the input of the transmission buffer 207 so as to output the playback start frame generated by the encoding unit 205.

Assume that the transcoding control unit 201 has analyzed the information 211 of the stream received from the stream decoding unit 203 and has determined that a frame after the playback start frame is obtained by referring to a frame preceding the playback start frame. In this case, the transcoding control unit 201 transmits the switching request 213 to the switch 206 to connect the output of the encoding unit 205 to the input of the transmission buffer 207, and transmits the decoded image data capture request 215 to the encoding unit 205 to capture the latest decoded image data 216 generated by the video decoding unit 204.

Upon determining that a frame after the playback start frame is obtained by referring to a frame preceding the playback start frame, the transcoding control unit 201 notifies the encoding unit 205 of the transcoding parameter information 214, of the information 211 of the video stream received from the stream decoding unit 203, which is required to generate a frame after the playback start frame. The transcoding parameter information 214 required to generate a frame after the playback start frame is, for example, a frame type (intra frame or inter frame), a frame number, time information, or a reference frame number.

Assume that the transcoding control unit 201 has analyzed the information 211 of the stream received from the stream decoding unit 203 and has determined that a frame after the playback start frame is obtained without referring to any frame preceding the playback start frame. In this case, the transcoding control unit 201 transmits the switching request 213 to the switch 206 to connect the output of the reception buffer 202 to the input of the transmission buffer 207, and transmits the transmission request 208 to the reception buffer 202 to output the video stream of the frame after the playback start frame to the switch 206 without any change.

The transcoding control unit 201 has a function of holding the number of frames or time information in the interval between the instant the playback start frame is generated and the instant the current frame is generated, transcoding the frame number, time information, and reference frame number of a video stream, when transcoding a frame after the playback start frame, and notifying the encoding unit 205 of the resultant data. The transcoding control unit 201 has a function of responding to a notification from the control information analysis unit 107 which requests the playback end position information 113.

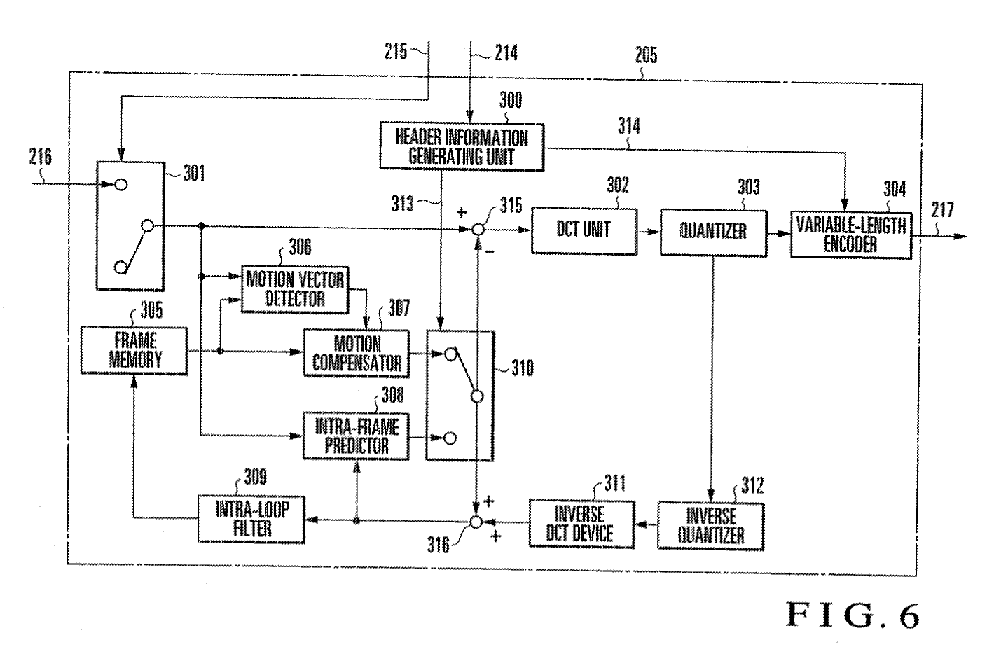

The encoding unit 205 will be described in detail next with reference to FIG. 6. FIG. 6 shows the detailed arrangement of the encoding unit 205 in FIG. 5. This exemplary embodiment exemplifies H.264 as a video compressing/encoding scheme. However, H.264 is merely an example, and the present invention is not limited to this. As is obvious from the principle of the present invention, the present invention can be applied to other video compressing/encoding schemes.

The encoding unit 205 comprises a header information generating unit 300, a switch 301, a DCT unit 302, a quantizer 303, a variable-length encoder 304, a frame memory 305, a motion vector detector 306, a motion compensator 307, an intra-frame predictor 308, an intra-loop filter 309, a switch 310, an inverse DCT device 311, an inverse quantizer 312, a subtractor 315, and an adder 316.

The header information generating unit 300 generates header information 314 on the basis of the transcoding parameter information 214 received from the transcoding control unit 201, and outputs the information to the variable-length encoder 304. In addition, if the frame type contained in the transcoding parameter information 214 indicates an intra frame, the header information generating unit 300 transmits a switching request 313 to the switch 310 to select an output from the intra-frame predictor 308. If the frame type contained in the transcoding parameter information 214 indicates an inter frame, the header information generating unit 300 transmits the switching request 313 to the switch 310 to select one of outputs from the intra-frame predictor 308 and the motion compensator 307.

Upon receiving the decoded image data capture request 215 from the transcoding control unit 201, the switch 301 performs switching operation to receive the latest decoded image data 216 from the video decoding unit 204 for a frame required to be transcoded, and outputs the decoded image data 216.

The other arrangements in FIG. 6 are the same as those of a general encoder, and hence will be briefly described.

The motion vector detector 306 detects a motion vector from the decoded image data 216 output from the switch 301.

The motion compensator 307 generates a prediction frame from the motion vector detected by the motion vector detector 306 and a reference frame stored in the frame memory 305.

The intra-frame predictor 308 generates a prediction frame on the basis of the decoded image data 216 output from the switch 301 and an output from the adder 316.

The intra-loop filter 309 reduces the block noise of an output from the adder 316. The frame memory 305 stores an output from the intra-loop filter 309 as a reference frame.

The subtractor 315 outputs the difference between the decoded image data 216 output from the switch 301 and an output from the switch 310 to the DCT unit 302.

The DCT unit 302 transcodes an output from the subtractor 315 into a frequency component by DCT processing. A quantizer 303 quantizes an output from the DCT unit 302.

The variable-length encoder 304 variable-length encodes an output from the quantizer 303, and outputs a video stream 217 obtained by this variable-length encoding to the switch 206.

The inverse quantizer 312 inversely quantizes an output from the quantizer 303. The inverse DCT device 311 performs inverse DCT processing for an output from the inverse quantizer 312.

The adder 316 outputs the sum of an output from the inverse DCT device 311 and an output from the switch 310 to the intra-frame predictor 308 and the intra-loop filter 309.

The switch 206 of the video transcoder 108 in FIG. 5 connects the input of the transmission buffer 207 to the output of the reception buffer 202 or encoding unit 205 in accordance with the switching request 213 from the transcoding control unit 201. Alternatively, the switch 206 disconnects the transmission buffer 207 from the reception buffer 202 or the encoding unit 205 in accordance with the switching request 213.

The transmission buffer 207 outputs a video stream 218 received from one of the reception buffer 202 and the encoding unit 205 via the switch 206 as the video stream 116 to the transmission/reception unit 109 in FIG. 2.

The transmission/reception unit 109 of the transcoding device 102 in FIG. 2 transmits the video stream selection information 115 received from the terminal 103 to the control information analysis unit 107. The transmission/reception unit 109 transmits the playback end position information received from the control information analysis unit 107 to the terminal 103 via the transmission path 105. The transmission/reception unit 109 transmits the video stream 116 received from the video transcoder 108 to the terminal 103.

The terminal 103 transmits, to the transcoding device 102, a video stream to be played back and the video stream selection information 115 which designates the playback start position of the video stream. The terminal 103 transmits a playback end request to the transcoding device 102 and receives playback end position information from the transcoding device 102 when the playback of the video stream is to be ended.

According to this exemplary embodiment, when transmitting a video stream to the terminal 103 upon transcoding it into a video stream which can be transmitted from an arbitrary position designated by the terminal 103, the transcoding device 102 analyzes the video stream and transcodes only a video stream in a range in which transcoding is required. This makes it possible to transcode a high-quality video stream at a high speed and transmit the video stream to the terminal 103.

In this exemplary embodiment, upon determining that the video stream received from the streaming server 101 has reached a playback start position, the transcoding control unit 201 of the video transcoder 108 causes the encoding unit 205 to generate a playback start frame. Upon determining that a frame after the playback start frame is required to be transcoded, the transcoding control unit 201 causes the encoding unit 205 to transcode the video stream. Upon determining that a frame after the playback start frame is not required to be transcoded, the transcoding control unit 201 outputs the video stream without any change. When a video stream is to be transmitted from the playback start position designated by the terminal 103, even if a frame after the playback start frame is obtained by referring to a frame preceding the playback start frame, the frame after the playback start frame is not disturbed. In addition, even if the start frame of the video stream is an intra frame, the high-quality video stream can be transmitted to the terminal 103 upon being transcoded at a high speed.

In this exemplary embodiment, the terminal 103 manages the playback history information of video streams by itself, and designates the playback start position of a desired video stream with respect to the transcoding device 102. This makes it unnecessary for the transcoding device 102 to hold the playback end position of a stream which is played back halfway for each terminal. Only receiving video stream selection information from the terminal 103 can transmit the video stream from halfway to the terminal 103.

### Second Exemplary Embodiment

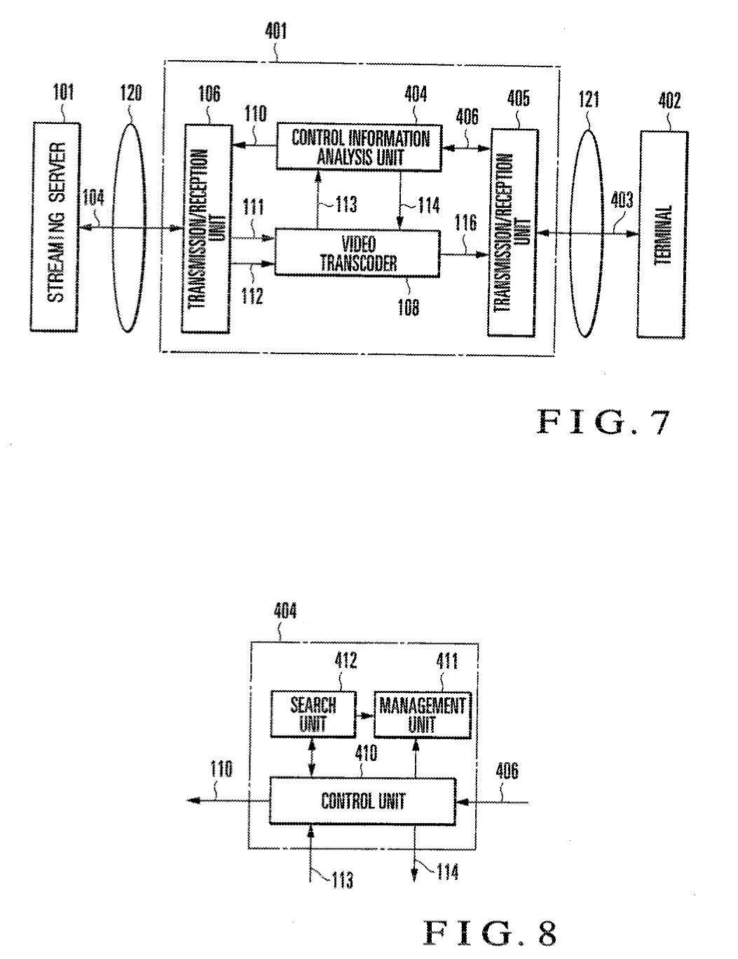

The second exemplary embodiment of the present invention will be described in detail next with reference to FIGS. 5 to 7. FIG. 7 shows the arrangement of a video streaming system according to the second exemplary embodiment of the present invention. The video streaming system of this exemplary embodiment comprises a streaming server 101, a transcoding device 401, a transmission path 104 which connects the streaming server 101 to the transcoding device 401, and a transmission path 403 which connects the transcoding device 401 to a terminal 402.

The arrangement and operation of the streaming server 101 are the same as those in the first exemplary embodiment.

The transcoding device 401 includes a transmission/reception unit 106, a control information analysis unit 404, a video transcoder 108, and a transmission/reception unit 405. The operations of the transmission/reception unit 106 and video transcoder 108 are the same as those in the first exemplary embodiment.

FIG. 8 shows the arrangement of the control information analysis unit 404. The control information analysis unit 404 comprises a control unit 410, a management unit 411 which manages the playback history information of video streams for each video stream or terminal, and a search unit 412 which specifies a playback start position by searching the playback history information on the basis of video stream selection information 406. The control unit 410 forms a reception unit which receives the video stream selection information 406 from the terminal 402.

The control unit 410 of the control information analysis unit 404 specifies the terminal 402 which is connected to the transcoding device 401. Information for specifying the terminal 402 is, for example, a telephone number or an authentication ID.

Upon receiving the video stream selection information 406 from the terminal 402 via the transmission/reception unit 405, the control unit 410 analyzes the video stream selection information 406 and specifies the video stream desired by the terminal 402 and playback start position information indicating the playback start position of the video stream. Playback start position information is, for example, selection information indicating that the video stream is played back from the head or selection information indicating that the playback of the video stream resumes from the position of the end of previous playback.

The management unit 411 of the control information analysis unit 404 manages video stream playback history information for the playback of a video stream from an arbitrary position on a stream or terminal basis in the form of a list. Video stream playback history information includes information indicating whether a video stream was played back in the past and information indicating the position of the end of previous playback if the video stream was played back in the past.

Assume that the control unit 410 of the control information analysis unit 404 has analyzed the video stream selection information 406 received from the terminal 402 and has obtained playback start position information indicating that the video stream is played back from the position of the end of previous playback. In this case, based on the information of the specified terminal 402 and the information of the video stream desired by the terminal 402, the search unit 412 searches the list in the management unit 411 for the position of the end of previous playback of the video stream. The control unit 410 of the control information analysis unit 404 notifies the video transcoder 108 of the found playback end position as the playback start position information 114 indicating this playback start position which is the position of the start of current playback.

Upon receiving a playback end request for a video stream from the terminal 402, the control unit 410 of the control information analysis unit 404 extracts playback end position information 113 from the video transcoder 108, and updates the playback end position of the video stream recorded in the list in the management unit 411.

The transmission/reception unit 405 transmits the video stream selection information 406 received from the terminal 402 to the control information analysis unit 404.

The terminal 402 transmits, to the transcoding device 401, a video stream to be played back and the video stream selection information 406 designating the playback start position of the video stream.

Arrangements and operations other than those described in this exemplary embodiment are the same as those in the first exemplary embodiment, and hence a repetitive description will be omitted.

According to this exemplary embodiment, when transmitting a video stream to the terminal 402 upon transcoding it into a video stream which can be transmitted from an arbitrary position designated by the terminal 402, the transcoding device 401 analyzes the video stream and transcodes only a video stream in a range in which transcoding is required. This makes it possible to transcode a high-quality video stream at a high speed and transmit the video stream to the terminal 402.

In this exemplary embodiment, upon determining that the video stream received from the streaming server 101 has reached a playback start position, a transcoding control unit 201 of the video transcoder 108 causes an encoding unit 205 of the video transcoder 108 to generate a playback start frame. Upon determining that a frame after the playback start frame is required to be transcoded, the transcoding control unit 201 causes the encoding unit 205 to transcode the video stream. Upon determining that a frame after the playback start frame is not required to be transcoded, the transcoding control unit 201 outputs the video stream without any change. When a video stream is to be transmitted from the playback start position designated by the terminal 402, even if a frame after the playback start frame is obtained by referring to a frame preceding the playback start frame, the frame after the playback start frame is not disturbed. In addition, even if the start frame of the video stream is an intra frame, the high-quality video stream can be transmitted to the terminal 402 upon being transcoded at a high speed.

In this exemplary embodiment, the transcoding device 401 manages the playback history information of video streams on a stream or terminal basis. This makes it unnecessary for the terminal 402 to hold the playback end position of a stream which is played back halfway. Only transmitting playback start position information indicating playback from the position of the end of previous playback to the transcoding device 401 can play back the video stream from halfway.

### Third Exemplary Embodiment

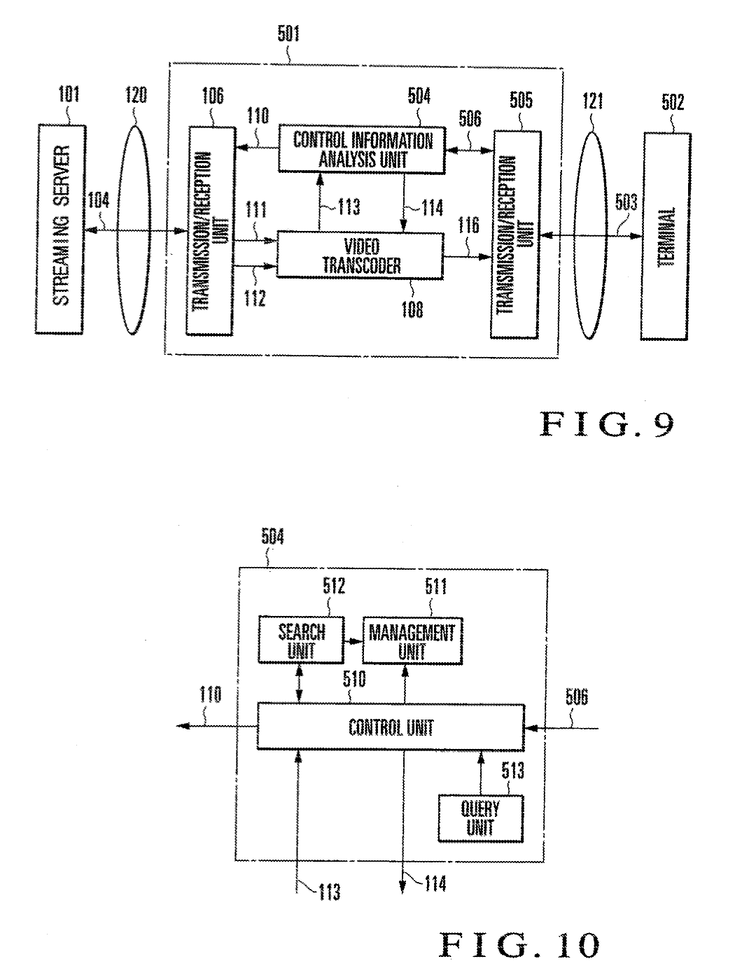

The third exemplary embodiment will be described in detail next with reference to FIGS. 5, 6, and 9. FIG. 9 shows the arrangement of a video streaming system according to the third exemplary embodiment of the present invention. The video streaming system according to this exemplary embodiment comprises a streaming server 101, a transcoding device 501, a transmission path 104 which connects the streaming server 101 to the transcoding device 501, and a transmission path 503 which connects the transcoding device 501 to a terminal 502.

The operation of the streaming server 101 is the same as that in the first exemplary embodiment.

The transcoding device 501 includes a transmission/reception unit 106, a control information analysis unit 504, a video transcoder 108, and a transmission/reception unit 505. The operations of the transmission/reception unit 106 and video transcoder 108 are the same as those in the first exemplary embodiment.

FIG. 10 shows the arrangement of the control information analysis unit 504. The control information analysis unit 504 comprises a control unit 510, a management unit 511 which manages the playback history information of video streams for each video stream or terminal, a search unit 512 which specifies a playback start position by searching the playback history information on the basis of video stream selection information 506, and a query unit 513. The control unit 510 forms a reception unit which receives the video stream selection information 506 from the terminal 502.

The control unit 510 of the control information analysis unit 504 specifies the terminal 502 which is connected to the transcoding device 501. Information for specifying the terminal 502 is, for example, a telephone number or an authentication ID.

Upon receiving a DTMF signal (video stream selection information 506) from the terminal 502 via the transmission/reception unit 505, the control unit 510 analyzes the DTMF signal and specifies the video stream desired by the terminal 502 and playback start position indicating the playback start position of the video stream. A DTMF (Dual Tone Multi Frequency) signal is, for example, a DTMF signal in the audio signal transmitted from the terminal 502 or a signal defined by IETF RFC2833.

The control information analysis unit 504 comprises the query unit 513. In order to specify a video stream or playback start position information from a DTMF signal, the query unit 513 may transmit, to the terminal 502, a stream on which at least one piece of information of, e.g., image information, audio information, and text information is recorded. Playback start position information is, for example, selection information indicating that the video stream is played back from the head or selection information indicating that the playback of the video stream resumes from the position of the end of previous playback.

The management unit 511 of the control information analysis unit 504 manages video stream playback history information for the playback of a video stream from an arbitrary position on a stream or terminal basis in the form of a list. Video stream playback history information includes information indicating whether a video stream was played back in the past and information indicating the position of the end of previous playback if the video stream was played back in the past.

Assume that the control unit 510 of the control information analysis unit 504 has analyzed the DTMF signal received from the terminal 502 and has obtained playback start position information indicating that playback is resumed from the position of the end of previous playback. In this case, the search unit 512 searches its list for the position of the end of previous playback of the video stream on the basis of the information of the specified terminal 502 and the information of the video stream desired by the terminal 502. The control unit 510 of the control information analysis unit 504 notifies the video transcoder 108 of the found playback end position as the playback start position information 114 indicating this playback start position which is the position of the start of current playback.

Upon receiving a playback end request for a video stream from the terminal 502, the control unit 510 of the control information analysis unit 504 extracts playback end position information 113 from the video transcoder 108, and updates the playback end position of the video stream recorded in the list.

The transmission/reception unit 505 transmits the DTMF signal (video stream selection information 506), received from the terminal 502, to the control information analysis unit 504.

The terminal 502 transmits a DTMF signal to the transcoding device 501 to designate a video stream to be played back and the playback start position of the video stream. In addition, upon receiving a stream on which at least one piece of information of image information, audio information, and text information is recorded, which prompts to select a video stream, from the transcoding device 501, the terminal 502 selects a desired video stream and the playback start position of the video stream in accordance with the received information, and transmits a DTMF signal to the transcoding device 501.

Arrangements and operations other than those described in this exemplary embodiment are the same as those in the first and second exemplary embodiments, and hence a repetitive description will be omitted.

According to this exemplary embodiment, when transmitting a video stream to the terminal 502 upon transcoding it into a video stream which can be transmitted from an arbitrary position designated by the terminal 502, the transcoding device 501 analyzes the video stream and transcodes only a video stream in a range in which transcoding is required. This makes it possible to transcode a high-quality video stream at a high speed and transmit the video stream to the terminal 502.

In this exemplary embodiment, upon determining that the video stream received from the streaming server 101 has reached a playback start position, a transcoding control unit 201 of the video transcoder 108 causes an encoding unit 205 of the video transcoder 108 to generate a playback start frame. Upon determining that a frame after the playback start frame is required to be transcoded, the transcoding control unit 201 causes the encoding unit 205 to transcode the video stream. Upon determining that a frame after the playback start frame is not required to be transcoded, the transcoding control unit 201 outputs the video stream without any change. When a video stream is to be transmitted from the playback start position desired by the terminal 502, even if a frame after the playback start frame is obtained by referring to a frame preceding the playback start frame, the frame after the playback start frame is not disturbed. In addition, even if the start frame of the video stream is an intra frame, the high-quality video stream can be transmitted to the terminal 502 upon being transcoded at a high speed.

In this exemplary embodiment, the transcoding device 501 manages the playback history information of video streams on a stream or terminal basis. This makes it unnecessary for the terminal 502 to hold the playback end position of a stream by itself which is played back halfway. Only transmitting playback start position information indicating that playback resumes from the position of the end of previous playback to the transcoding device 501 can play back the video stream from halfway.

Furthermore, according to this exemplary embodiment, when the transcoding device 501 is to transmit a stream on which at least one piece of information of image information, audio information, and text information is recorded, which prompts to select a video stream, the user of the terminal 502 can select a video stream and its playback start position while seeing the stream. This makes it unnecessary for the terminal 502 to hold a playback start position and the like. The terminal 502 can operate on the basis of the instruction indicated by a DTMF signal. Therefore, the management unit 511 need not hold video stream history information as in the above case. This can reduce the amount of information to be held in both the terminal 502 and the transcoding device 501 to play back from halfway.

### Fourth Exemplary Embodiment

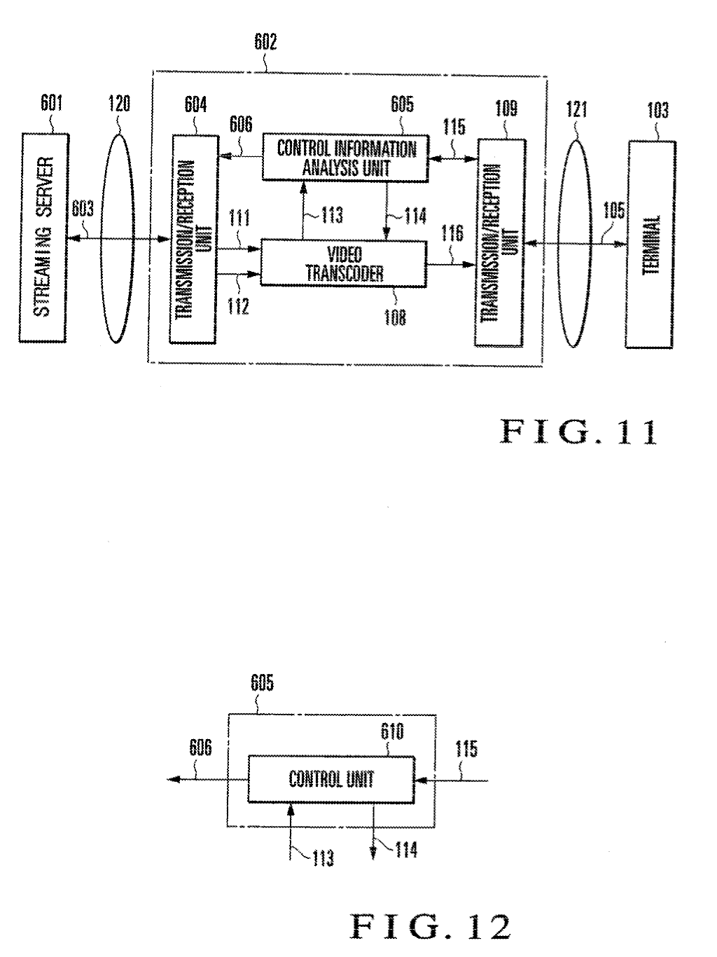

The fourth exemplary embodiment of the present invention will be described in detail next with reference to FIGS. 5, 6, and 11. FIG. 11 shows the arrangement of a video streaming system according to the fourth exemplary embodiment of the present invention. The video streaming system of this exemplary embodiment comprises a streaming server 601, a transcoding device 602, a transmission path 603 which connects the streaming server 601 to the transcoding device 602, and a transmission path 105 which connects the transcoding device 602 to a terminal 103.

The streaming server 601 stores video streams. The arrangement of the streaming server 601 is the same as that of the streaming server 101 shown in FIG. 3, and hence will be described with reference to the reference numerals in FIG. 3. Upon receiving video stream designation information from the transcoding device 602, a streaming control unit 2001 of the streaming server 601 transmits the decoded information of a designated video stream and the designated video stream to the transcoding device 602 via the transmission path 603.

The video stream designation information transmitted from the transcoding device 602 contains the playback start position information of the video stream. Upon receiving video stream designation information from the transcoding device 602, the streaming control unit 2001 of the streaming server 601 starts transmitting the video stream from an intra-frame prediction frame immediately preceding the playback start position designated by the playback start position information of this video stream designation information. Note, however, that if, for example, there is a restriction that the start frame of a video stream is an IDR (Instantaneous Decoding Refresh) frame as in H.264, it suffices to start streaming an intra-frame prediction frame complying with the restriction of the recommendation.

The transcoding device 602 comprises a transmission/reception unit 604, a control information analysis unit 605, a video transcoder 108, and a transmission/reception unit 109. The operations of the video transcoder 108 and transmission/reception unit 109 are the same as those in the first exemplary embodiment.

FIG. 12 shows the arrangement of the control information analysis unit 605. The control information analysis unit 605 includes a control unit 610. The control unit 610 forms a video stream designation information transmission unit which transmits video stream designation information to the streaming server 601.

The control information analysis unit 605 analyzes video stream selection information 115 of the terminal 103 which is received from the transmission/reception unit 109, and specifies the video stream desired by the terminal 103 and the playback start position of the video stream. Information which specifies the video stream desired by the terminal 103 is, for example, the name or list number of the video stream, a telephone number, or URL. Information which specifies the playback start position of a video stream is, for example, time information from the head of the stream, a frame number, or a track number obtained by dividing the stream by a predetermined time.

The control information analysis unit 605 generates video stream designation information 606 which requests the streaming server 601 so as to transmit the video stream desired by the terminal 103, and transmits the video stream designation information 606 to the transmission/reception unit 604. At this time, the control information analysis unit 605 designates the video stream specified by analysis by the video stream selection information 115 and the playback start position of the video stream by using the video stream designation information 606.

The transmission/reception unit 604 transmits the video stream designation information 606, transmitted by the control information analysis unit 605, to the streaming server 601 via the transmission path 603.

Arrangements and operations other than those described in this exemplary embodiment are the same as those in the first exemplary embodiment, and hence a repetitive description will be omitted.

According to this exemplary embodiment, when transmitting a video stream to the terminal 103 upon transcoding it into a video stream which can be transmitted from an arbitrary position designated by the terminal 103, the transcoding device 602 analyzes the video stream and transcodes only a video stream in a range in which transcoding is required. This makes it possible to transcode a high-quality video stream at a high speed and transmit the video stream to the terminal 103.

In this exemplary embodiment, upon determining that the video stream received from the streaming server 601 has reached a playback start position, a transcoding control unit 201 of the video transcoder 108 causes an encoding unit 205 of the video transcoder 108 to generate a playback start frame. Upon determining that a frame after the playback start frame is required to be transcoded, the transcoding control unit 201 causes the encoding unit 205 to encode the video stream. Upon determining that a frame after the playback start frame is not required to be transcoded, the transcoding control unit 201 outputs the video stream without any change. When a video stream is to be transmitted from the playback start position designated by the terminal 103, even if a frame after the playback start frame is obtained by referring to a frame preceding the playback start frame, the frame after the playback start frame is not disturbed. In addition, even if the start frame of the video stream is an intra frame, the high-quality video stream can be transmitted to the terminal 103 upon being transcoded at a high speed.

In this exemplary embodiment, the terminal 103 manages the playback history information of video streams by itself, and designates the playback start position of a desired video stream with respect to the transcoding device 602. This makes it unnecessary for the transcoding device 602 to hold the playback end position of a stream which is played back halfway for each terminal. Only receiving video stream selection information from the terminal 103 can transmit the video stream from halfway to the terminal 103.

Furthermore, according to this exemplary embodiment, when the transcoding device 602 transmits the playback start position information of a video stream to the streaming server 601, the streaming server 601 transmits the video stream from a frame near the playback start position designated by this playback start position information. This can shorten the time required to transmit a video stream to the terminal 103 as compared with the first to third exemplary embodiments.

### Fifth Exemplary Embodiment

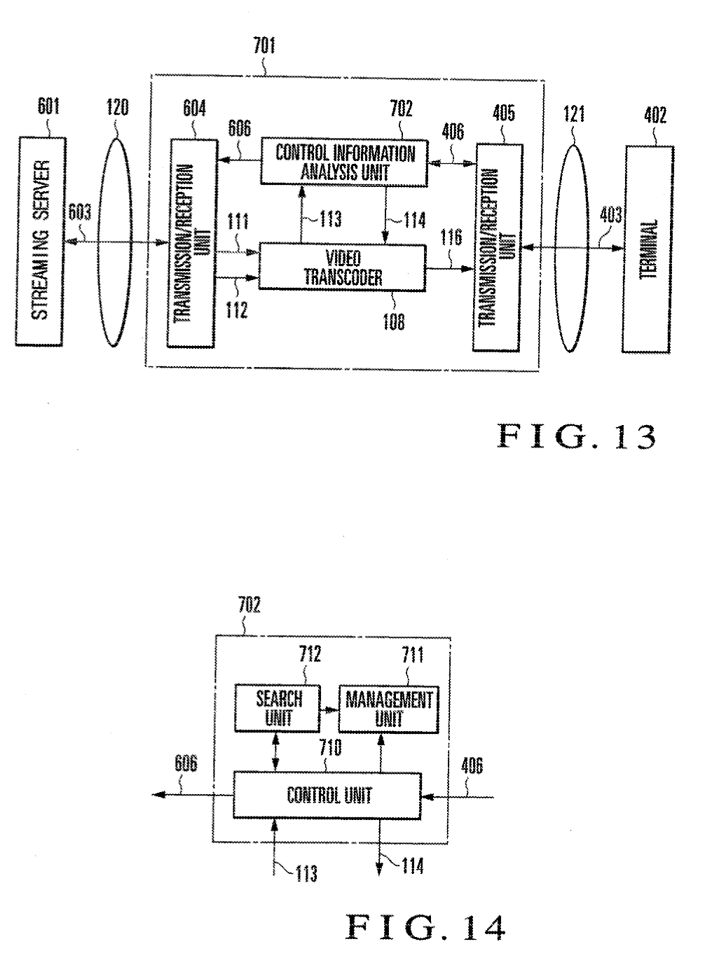

The fifth exemplary embodiment of the present invention will be described in detail next with reference to FIGS. 5, 6, and 13. FIG. 13 shows the arrangement of a video streaming system according to the fifth exemplary embodiment. The video streaming system of this exemplary embodiment comprises a streaming server 601, a transcoding device 701, a transmission path 603 which connects the streaming server 601 to the transcoding device 701, and a transmission path 403 which connects the transcoding device 701 to a terminal 402.

The arrangement and operation of the streaming server 601 are the same as those in the fourth exemplary embodiment.

The transcoding device 701 includes a transmission/reception unit 604, a control information analysis unit 702, a video transcoder 108, and a transmission/reception unit 405. The operation of the video transcoder 108 is the same as that in the first exemplary embodiment. The operation of the transmission/reception unit 405 is the same as that in the second exemplary embodiment. The operation of the transmission/reception unit 604 is the same as that in the fourth exemplary embodiment.

FIG. 14 shows the arrangement of a control information analysis unit 702. The control information analysis unit 702 comprises a control unit 710, a management unit 711 which manages the playback history information of video streams for each video stream or terminal, and a search unit 712 which specifies a playback start position by searching the playback history information on the basis of video stream selection information 406. The control unit 710 comprises a reception unit which receives the video stream selection information 406 from the terminal 402 and a video stream designation information transmission unit which transmits the video stream designation information to the streaming server 601.

The control unit 710 of the control information analysis unit 702 specifies the terminal 402 which is connected to a transcoding device 701. Information for specifying the terminal 402 is, for example, a telephone number or an authentication ID.

Upon receiving the video stream selection information 406 from the terminal 402 via the transmission/reception unit 405, the control unit 710 analyzes the video stream selection information 406 and specifies the video stream desired by the terminal 402 and the playback start position information indicating the playback start position of the video stream. Playback start position information is, for example, selection information indicating that the video stream is played back from the head or selection information indicating that the playback of a video stream resumes from the position of the end of previous playback.

The management unit 711 of the control information analysis unit 702 manages video stream playback history information for the playback of a video stream from an arbitrary position on a stream or terminal basis in the form of a list. Video stream playback history information includes information indicating whether a video stream was played back in the past and information indicating the position of the end of previous playback if the video stream was played back in the past.

Assume that the control unit 710 of the control information analysis unit 702 has analyzed the video stream selection information 406 received from the terminal 402 and has obtained playback start position information indicating that playback resumes from the position of the end of previous playback. In this case, based on the information of the specified terminal 402 and the information of the video stream desired by the terminal 402, the search unit 712 searches its list for the position of the end of previous playback of the video stream.

The control unit 710 of the control information analysis unit 702 generates video stream designation information 606 which requests the streaming server 601 so as to transmit the video stream desired by the terminal 402, and transmits the video stream designation information 606 to the transmission/reception unit 604. At this time, the control unit 710 designates the video stream specified by analysis by the video stream selection information 406 by using the video stream designation information 606, and also designates the playback end position of the video stream, which is searched out from the list, as the current playback start position, by using the video stream designation information 606. The control unit 710 notifies the video transcoder 108 of the found playback end position as the playback start position information 114 indicating this playback start position which is the position of the start of current playback.

Upon receiving the playback end request for the video stream from the terminal 402, the control unit 710 of the control information analysis unit 702 extracts playback end position information 113 from the video transcoder 108 and updates the playback end position of the video stream recorded in the list in the management unit 711.

Arrangements and operations other than those described in this exemplary embodiment are the same as those in first and second exemplary embodiments, and hence a repetitive description will be omitted.

According to this exemplary embodiment, when transmitting a video stream to the terminal 402 upon transcoding it into a video stream which can be transmitted from an arbitrary position designated by the terminal 402, the transcoding device 701 analyzes the video stream and transcodes only a video stream in a range in which transcoding is required. This makes it possible to transcode a high-quality video stream at a high speed and transmit the video stream to the terminal 402.

In this exemplary embodiment, upon determining that the video stream received from the streaming server 601 has reached a playback start position, a transcoding control unit 201 of the video transcoder 108 causes an encoding unit 205 of the video transcoder 108 to generate a playback start frame. Upon determining that a frame after the playback start frame is required to be transcoded, the transcoding control unit 201 causes the encoding unit 205 to transcode the video stream. Upon determining that a frame after the playback start frame is not required to be transcoded, the transcoding control unit 201 outputs the video stream without any change. When a video stream is to be transmitted from the playback start position designated by the terminal 402, even if a frame after the playback start frame is obtained by referring to a frame preceding the playback start frame, the frame after the playback start frame is not disturbed. In addition, even if the start frame of the video stream is an intra frame, the high-quality video stream can be transmitted to the terminal 402 upon being transcoded at a high speed.

In this exemplary embodiment, the transcoding device 701 manages the playback history information of video streams on a stream or terminal basis. This makes it unnecessary for the terminal 402 to hold the playback end position of a stream which is played back halfway. Only transmitting playback start position information indicating that playback resumes from the position of the end of previous playback to the transcoding device 701 can play back the video stream from halfway.

Furthermore, according to this exemplary embodiment, when the transcoding device 701 transmits the playback start position information of a video stream to the streaming server 601, the streaming server 601 transmits the video stream from a frame near the playback start position designated by this playback start position information. This can shorten the time required to transmit a video stream to the terminal 402 as compared with the first to third exemplary embodiments.

### Sixth Exemplary Embodiment

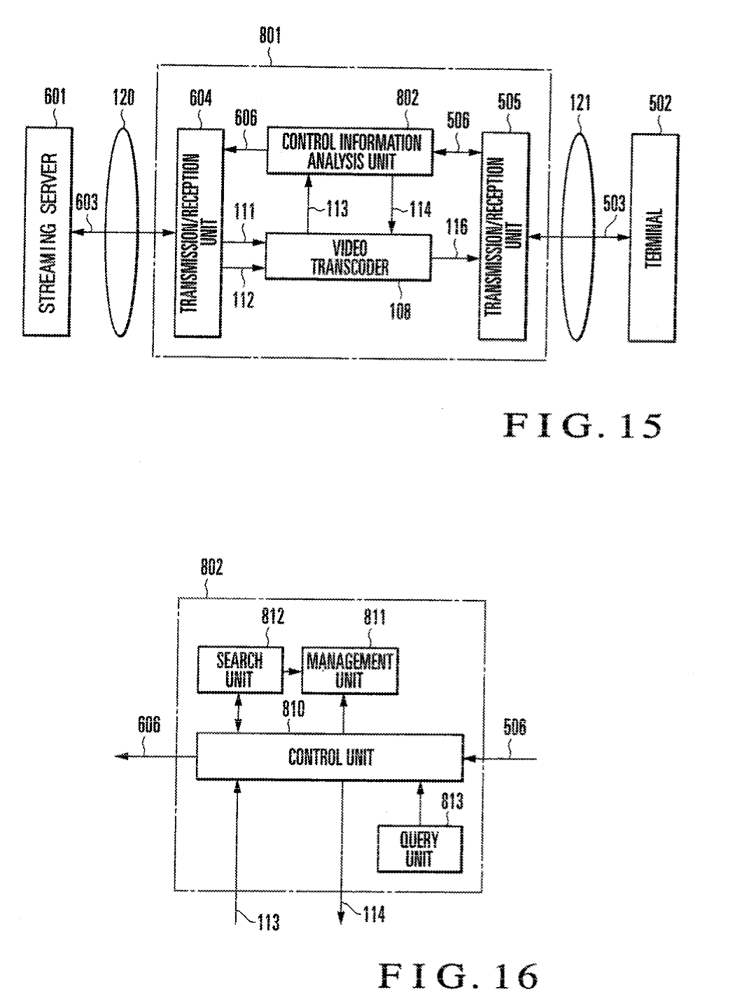

The sixth exemplary embodiment of the present invention will be described in detail next with reference to FIGS. 5, 6, and 15. FIG. 15 shows the arrangement of a video streaming system according to the sixth exemplary embodiment of the present invention. The video streaming system according to this exemplary embodiment comprises a streaming server 601, a transcoding device 801, a transmission path 603 which connects the streaming server 601 to the transcoding device 801, and a transmission path 503 which connects the transcoding device 801 to a terminal 502.

The operation of the streaming server 601 is the same as that in the fourth exemplary embodiment.

The transcoding device 801 includes a transmission/reception unit 604, a control information analysis unit 802, a video transcoder 108, and a transmission/reception unit 505. The operation of the video transcoder 108 is the same as that in the first exemplary embodiment. The operation of the transmission/reception unit 505 is the same as that in the third exemplary embodiment. The operation of the transmission/reception unit 604 is the same as that in the fourth exemplary embodiment.

FIG. 16 shows the arrangement of the control information analysis unit 802. The control information analysis unit 802 comprises a control unit 810, a management unit 811 which manages the playback history information of video streams for each video stream or terminal, a search unit 812 which specifies a playback start position by searching the playback history information on the basis of video stream selection information 506, and a query unit 813. The control unit 810 comprises a reception unit which receives the video stream selection information 506 from the terminal 502 and a video stream designation information transmission unit which transmits video stream designation information to the streaming server 601.

The control unit 810 of the control information analysis unit 802 specifies the terminal 502 which is connected to the transcoding device 801. Information for specifying the terminal 502 is, for example, a telephone number or an authentication ID.

Upon receiving a DTMF signal (video stream selection information 506) from the terminal 502 via the transmission/reception unit 505, the control unit 810 analyzes the DTMF signal and specifies the video stream desired by the terminal 502 and playback start position information indicating the playback start position of the video stream. A DTMF signal is, for example, a DTMF signal in the audio signal transmitted from the terminal 502 or a signal defined by IETF RFC2833.

The control information analysis unit 802 comprises the query unit 813. In order to specify a video stream or playback start position information from a DTMF signal, the query unit 813 may transmit, to the terminal 502, a stream on which at least one piece of information of, e.g., image information, audio information, and text information is recorded. Playback start position information is, for example, selection information indicating that the playback of a video stream starts from the head or selection information indicating that the playback of a video stream resumes from the position of the end of previous playback.

The management unit 811 of the control information analysis unit 802 manages video stream playback history information for the playback of a video stream from an arbitrary position on a stream or terminal basis in the form of a list. Video stream playback history information includes information indicating whether a video stream was played back in the past and information indicating the position of the end of previous playback if the video stream was played back in the past.

Assume that the control unit 810 of the control information analysis unit 802 has analyzed the DTMF signal received from the terminal 502 and has obtained playback start position information indicating that playback resumes from the position of the end of previous playback. In this case, the search unit 812 searches its list for the position of the end of previous playback of the video stream on the basis of the information of the specified terminal 502 and the information of the video stream desired by the terminal 502.

The control unit 810 of the control information analysis unit 802 generates video stream designation information 606 which requests the streaming server 601 to transmit the video stream desired by the terminal 502, and transmits the video stream designation information 606 to the transmission/reception unit 604. At this time, the control unit 810 designates the video stream specified by analysis on the DTMF signal by using the video stream designation information 606, and also designates the playback end position of the video stream, which is searched out from the list, as the current playback start position, by using the video stream designation information 606. The control unit 810 notifies the video transcoder 108 of the found playback end position as playback start position information 114 indicating this playback start position which is the position of the start of current playback.

Upon receiving the playback end request for the video stream from the terminal 502, the control unit 810 of the control information analysis unit 802 extracts playback end position information 113 from the video transcoder 108 and updates the playback end position of the video stream recorded in the list.

Arrangements and operations other than those described in this exemplary embodiment are the same as those in the first to third exemplary embodiments, and hence a repetitive description will be omitted.

According to this exemplary embodiment, when transmitting a video stream to the terminal 502 upon transcoding it into a video stream which can be transmitted from an arbitrary position designated by the terminal 502, the transcoding device 802 analyzes the video stream and transcodes only a video stream in a range in which transcoding is required. This makes it possible to transcode a high-quality video stream at a high speed and transmit the video stream to the terminal 502.

In this exemplary embodiment, upon determining that the video stream received from the streaming server 601 has reached a playback start position, a transcoding control unit 201 of the video transcoder 108 causes an encoding unit 205 of the video transcoder 108 to generate a playback start frame. Upon determining that a frame after the playback start frame is required to be transcoded, the transcoding control unit 201 causes the encoding unit 205 to transcode the video stream. Upon determining that a frame after the playback start frame is not required to be transcoded, the transcoding control unit 201 outputs the video stream without any change. When a video stream is to be transmitted from the playback start position designated by the terminal 502, even if a frame after the playback start frame is obtained by referring to a frame preceding the playback start frame, the frame after the playback start frame is not disturbed. In addition, even if the start frame of the video stream is an intra frame, the high-quality video stream can be transmitted to the terminal 502 upon being transcoded at a high speed.

In this exemplary embodiment, the transcoding device 802 manages the playback history information of video streams on a stream or terminal basis. This makes it unnecessary for the terminal 502 to hold the playback end position of a stream which is played back halfway. Only transmitting playback start position information indicating that playback resumes from the position of the end of previous playback to the transcoding device 802 can play back the video stream from halfway.

Furthermore, according to this exemplary embodiment, when the transcoding device 802 is to transmit a stream on which at least one piece of information of image information, audio information, and text information is recorded, which prompts to select a video stream, the user of the terminal 502 can select a video stream and its playback start position while seeing the stream. This makes it unnecessary for the terminal 502 to hold a playback start position and the like. The transcoding device 802 can operate on the basis of the instruction indicated by a DTMF signal, and hence need not hold video stream history information as in the above case. This can reduce the amount of information to be held in both the terminal 502 and the transcoding device 802 to play back from halfway.

Furthermore, according to this exemplary embodiment, when the transcoding device 802 transmits the playback start position information of a video stream to the streaming server 601, the streaming server 601 transmits the video stream from a frame near the playback start position designated by this playback start position information. This can shorten the time required to transmit a video stream to the terminal 502 as compared with the first to third exemplary embodiments.

### Seventh Exemplary Embodiment

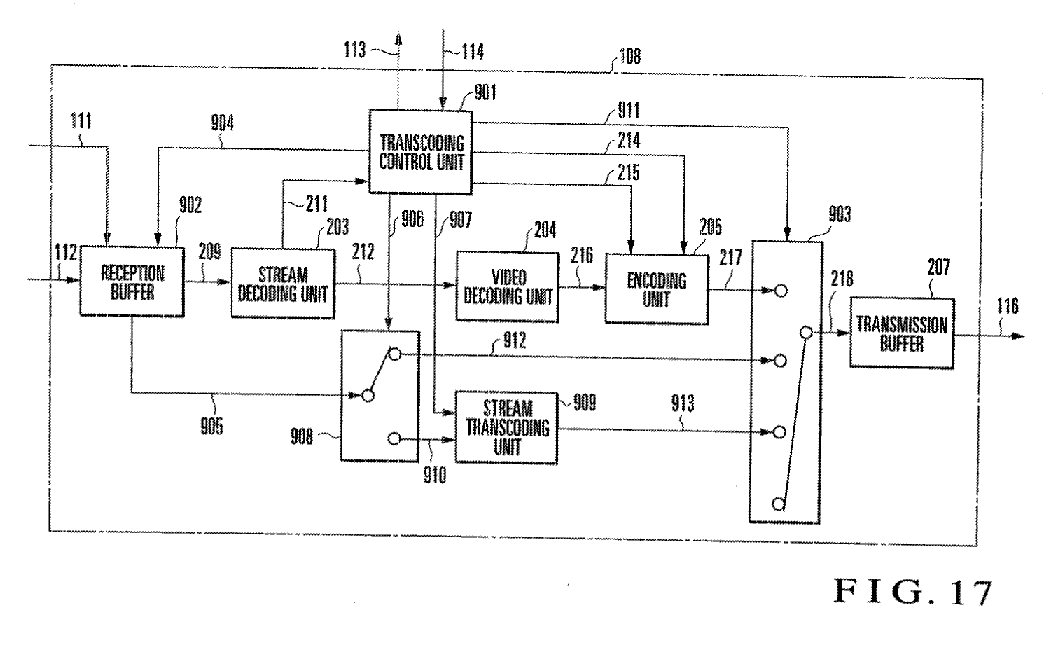

The seventh exemplary embodiment of the present invention will be described in detail with reference to FIGS. 2 and 7 to 17. The arrangement of a video streaming system according to this exemplary embodiment is the same as that in the first exemplary embodiment, and hence will be described with reference to reference numerals in FIG. 2. FIG. 17 shows the arrangement of a video transcoder 108 according to the seventh exemplary embodiment of the present invention.

The video transcoder 108 of this exemplary embodiment comprises a transcoding control unit 901, a reception buffer 902, a stream decoding unit 203, a video decoding unit 204, an encoding unit 205, a switch 908, a stream transcoding unit 909, a switch 903, and a transmission buffer 207.

The reception buffer 902 receives decoding information 111 and a video stream 112 transmitted from a transmission/reception unit 106, and transmits them to the stream decoding unit 203. The reception buffer 902 has a function of detecting a break for each frame or slice of the video stream 112. Upon receiving a transmission request 904 to output a stream to the switch 908 from the transcoding control unit 901, the reception buffer 902 divides the video stream 112 on a frame basis or a slice basis and transmits it as a video stream 905 to the switch 908. The reception buffer 902 detects a break for each frame or slice of the video stream 112 on the basis of a unique bit string such as a start code.

The operations of the stream decoding unit 203 and video decoding unit 204 are the same as those in the first exemplary embodiment.

The transcoding control unit 901 stores a playback start position information 114 of the stream notified from a control information analysis unit 107 as information indicating the transcoding start position of the stream.

The transcoding control unit 901 analyzes information 211 of the stream received from the stream decoding unit 203 and determines whether a video stream 209 received by the stream decoding unit 203 has reached the transcoding start position. Upon determining that the video stream 209 has reached the transcoding start position, the transcoding control unit 901 transmits a decoded image data capture request 215 to the encoding unit 205 to generate a playback start frame from latest decoded image data 216 generated by the video decoding unit 204.

Upon determining that the video stream 209 has reached the transcoding start position, the transcoding control unit 901 notifies the encoding unit 205 of transcoding parameter information 214 required to generate a playback start frame. Of the transcoding parameter information 214, information required to generate a playback start frame is, for example, decoding information or a frame type (intra-frame prediction frame). Upon determining that the video stream 209 has reached the transcoding start position, the transcoding control unit 901 transmits a switching request 911 to the switch 903 to connect the output of the encoding unit 205 to the input of the transmission buffer 207 so as to output the playback start frame generated by the encoding unit 205.

Assume that the transcoding control unit 901 has analyzed the information 211 of the stream received from the stream decoding unit 203 and has determined from, for example, the decoding information of the information 211 that there is no correlation between slices or macroblocks of the corresponding frames. In this case, the transcoding control unit 901 specifies portions in the video stream which require transcoding on a slice or macroblock basis.

The transcoding control unit 901 also analyzes the information 211 received from the stream decoding unit 203 and determines whether a frame after the playback start frame is obtained by referring to a frame preceding the playback start frame on a slice basis. At this time, the transcoding control unit 901 specifies a range in which transcoding is required by using, for example, a macroblock number.

Upon determining that a frame after the playback start frame is obtained by referring to a frame preceding the playback start frame, the transcoding control unit 901 transmits the switching request 911 to the switch 903 to connect the output of the encoding unit 205 to the input to the transmission buffer 207, and transmits a decoded image data capture request 215 to the encoding unit 205 to capture the latest decoded image data 216 generated by the video decoding unit 204. At this time, the transcoding control unit 901 transmits the information of the macroblock number of a slice of the video stream requiring transcoding to the encoding unit 205, together with the decoded image data capture request 215.

As in the first exemplary embodiment, the encoding unit 205 transcodes the decoded image data 216 generated by the video decoding unit 204 and outputs a video stream 217 to the switch 903. At this time, the encoding unit 205 transcodes only a slice, of the decoded image data 216, which is required to be transcoded, on the basis of the information of the macroblock number and the like transmitted from the transcoding control unit 901, and outputs the resultant data, while outputting a slice requiring no transcoding without any change.

Assume that the transcoding control unit 901 has analyzed the information 211 of the stream received from the stream decoding unit 203 and has determined that a frame after the playback start frame is obtained without referring to any frame preceding the playback start frame. In this case, the transcoding control unit 901 outputs the transmission request 904 to the reception buffer 902 to output the video stream of the frame after the playback start frame to the switch 908 without any change.

Upon analyzing the information 211 of the stream and determining that the frame after the playback start frame is obtained without referring to any frame preceding the playback start frame, the transcoding control unit 901 checks whether there is any parameter as information which is required to be transcoded. In this case, a parameter whose necessity of transcoding is to be checked is, for example, a frame number or time information.

If there is a parameter which is required to be transcoded, the transcoding control unit 901 notifies the stream transcoding unit 909 of transcoding parameter information 907 indicating a frame number after transcoding or time information, together with the information of the macroblock number of a slice which is required to be transcoded. The transcoding control unit 901 also transmits a switching request 906 to the switch 908 to output the video stream 905 from the reception buffer 202 as the slice whose parameter is required to be transcoded to the stream transcoding unit 909, and transmits a switching request 911 to the switch 903 to connect the output of the stream transcoding unit 909 to the input of the transmission buffer 207.

Assume that the transcoding control unit 901 has analyzed the information 211 of the stream, and has determined that the frame after the playback start frame is obtained without referring to any frame preceding the playback start frame, and that there is no parameter which is required to be transcoded. In this case, the transcoding control unit 901 transmits the switching request 906 to the switch 908 to output, to the switch 903, the video stream 905 from the reception buffer 202 as a video stream 912 which is the slice that is not required to be transcoded, and transmits the switching request 911 to the switch 903 to connect the output of the switch 908 to the input of the transmission buffer 207.

The transcoding control unit 901 compares the frame number or time information of a video stream with the number of frames or time information in the interval between the instant the playback start frame is generated and the instant the current frame is generated. If there is a difference between them, the transcoding control unit 901 transcodes the frame number or the time information, and notifies the encoding unit 205 or the stream transcoding unit 909 of the resultant data.

The switch 908 connects the output of the reception buffer 902 to the input of the switch 903 or stream transcoding unit 909 in accordance with the switching request 906 from the transcoding control unit 901.

The switch 903 connects the input of the transmission buffer 207 to the output of the switch 908 or stream transcoding unit 909 in accordance with the switching request 911 from the transcoding control unit 901. Alternatively, the switch 903 disconnects the transmission buffer 207 from the encoding unit 205, the switch 908, and the stream transcoding unit 909 in accordance with the switching request 911.

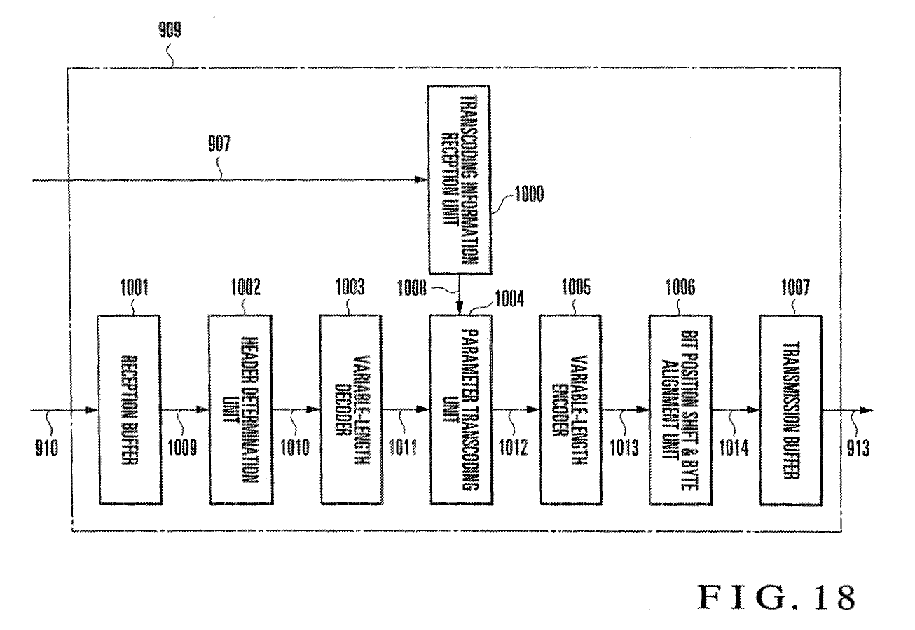

The stream transcoding unit 909 in FIG. 17 will be described in detail with reference to FIG. 18. FIG. 18 shows the detailed arrangement of the stream transcoding unit 909 in FIG. 17.

The stream transcoding unit 909 comprises a transcoding information reception unit 1000, a reception buffer 1001, a header determination unit 1002, a variable-length decoder 1003, a parameter transcoding unit 1004, a variable-length encoder 1005, a bit position shift & byte alignment unit 1006, and a transmission buffer 1007.

The transcoding information reception unit 1000 transmits the transcoding parameter information 907 received from the transcoding control unit 901 as transcoding parameter information 1008 to the parameter transcoding unit 1004.

The reception buffer 1001 transmits a video stream 910 received from the reception buffer 902 via the switch 908 as a video stream 1009 to the header determination unit 1002.

The header determination unit 1002 detects a break for each frame or slice of the video stream 1009 received from the reception buffer 1001.

The variable-length decoder 1003 decodes a video stream 1010 for each frame or slice detected by the header determination unit 1002 to transcode the stream into a parameter. A transcoded parameter 1011 is transmitted to the parameter transcoding unit 1004.

The parameter transcoding unit 1004 transcodes, for example, a frame number or time information of the transcoded parameters 1011 received from the variable-length decoder 1003 in accordance with the transcoding parameter information 1008 received from the transcoding information reception unit 1000.

The variable-length encoder 1005 variable-length encodes a parameter 1012 after transcoding which is received from the parameter transcoding unit 1004, and outputs a video stream 1013 obtained by the variable-length encoding to the bit position shift & byte alignment unit 1006.

The bit position shift & byte alignment unit 1006 shifts the bit position of a parameter, of the video stream 1013 output from the variable-length encoder 1005, which follows the parameter transcoded by the parameter transcoding unit 1004. The bit position shift & byte alignment unit 1006 performs byte alignment processing for each of slice or frame of the video stream 1013.

The transmission buffer 1007 outputs a video stream 1014 after transcoding, which is received from the bit position shift & byte alignment unit 1006, as a video stream 913 to the switch 903. With the above processing, the operation of the stream transcoding unit 909 ends.

Arrangements and operations other than those described in this exemplary embodiment are the same as those in the first to sixth exemplary embodiments, and hence a repetitive description will be omitted.

According to this exemplary embodiment, the transcoding device 102 can transmit a high-quality video stream to the terminal 103 upon transcoding the video stream at a high speed. In addition, according to this exemplary embodiment, when a video stream is to be transmitted from the playback start position desired by the terminal 103, even if a frame after the playback start frame is obtained by referring to a frame preceding the playback start frame, the frame after the playback start frame is not disturbed.

In this exemplary embodiment, when transcoding can be done on a slice basis, only a slice of a video stream which is required to be transcoded is transcoded by the video transcoder 108, and a slice which is not required to be transcoded is output from the video transcoder 108 without any change. This makes it possible to transcode a video stream and transmit the resultant data to the terminal 103 at a higher speed than the video transcoder in the first exemplary embodiment.

Note that this exemplary embodiment has exemplified the case in which the video transcoder 108 shown in FIG. 17 is applied to the first exemplary embodiment. However, the video transcoder 108 can be applied to the second to sixth exemplary embodiments.

### Eighth Exemplary Embodiment

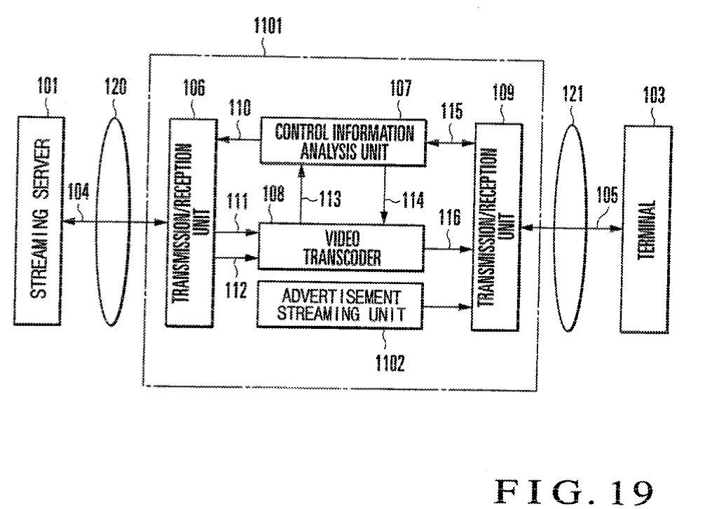

The eighth exemplary embodiment of the present invention will be described in detail with reference to FIG. 19. FIG. 19 shows the arrangement of a video streaming system according to the eighth exemplary embodiment of the present invention. The video streaming system according to this exemplary embodiment comprises a streaming server 101, a transcoding device 1101, a transmission path 104 which connects the streaming server 101 to the transcoding device 1101, and a transmission path 105 which connects the transcoding device 1101 to a terminal 103.

The transcoding device 1101 according to this exemplary embodiment is the same as the transcoding device 102 in the first exemplary embodiment except that an advertisement streaming unit 1102 is added.

When transmitting at least one video stream desired by the terminal 103, the advertisement streaming unit 1102 transmits, to the terminal 103, a stream in which at least one piece of information of image information, audio information, and text information which represents a propaganda or an advertisement is recorded before or after the video stream.

In this manner, this exemplary embodiment can perform a propaganda activity for the user of the terminal 103.

Obviously, the advertisement streaming unit 1102 in this exemplary embodiment can be applied to the second to seventh exemplary embodiments.

Note that in the first to eighth exemplary embodiments, the network 121 which connects a transcoding device to a terminal can be a circuit switched network, a packet switched network, or a network including both a packet switched network and a circuit switched network.

The transcoding device of each of the first to eighth exemplary embodiments can be implemented by a computer comprising a CPU (Central Processing Unit), a storage device, and an interface for an external unit, and a program which controls the hardware sources. The CPU executes the processing described in each of the first to eighth exemplary embodiments in accordance with the program stored in the storage device.

Although the present invention has been described with reference to the above exemplary embodiments, the present invention is not limited to the above exemplary embodiments. The arrangements and details of the present invention can be implemented by properly combining the above exemplary embodiments, and can be properly changed within the appended claims of the present invention.

The present application claims the priority based on Japanese Patent Application No. 2007-136449 filed on May 23, 2007, and the entire contents of which are incorporated herein by reference.

### INDUSTRIAL APPLICABILITY

The present invention can be applied to techniques of streaming videos.

1. A video streaming system characterized by comprising:
a streaming server that stores a video stream; and
a transcoding device that transmits, to a terminal via a network, a video stream received from said streaming server upon transcoding the video stream into a video stream that is configured to be transmitted from an arbitrary position designated by the terminal, wherein
said transcoding device is configured to receive a video stream desired by the terminal from said streaming server, and to analyze the video stream to covert only a portion of the video stream that falls within a range in which transcoding is required, when transmitting the video stream to the terminal upon transcoding the video stream into a video stream that is configured to be transmitted from an arbitrary position designated by the terminal.

2. The video streaming system according to claim 1, characterized in that said transcoding device comprises
a control information analysis unit that specifies a video stream desired by the terminal and a playback start position of the video stream,
a first transmission/reception unit that receives the video stream desired by the terminal from said streaming server;
a video transcoder that analyzes a video stream received from said streaming server and transcodes only a portion of the video stream that falls within a range in which transcoding is required, when transmitting the video stream from the playback start position, and
a second transmission/reception unit that transmits a video stream output from the video transcoder to the terminal.

3. The video streaming system according to claim 2, characterized in that the video transcoder comprises
a transcoding control unit that analyzes a video stream received from said streaming server and controls the transcoding,
a playback start frame generating unit that generates and outputs a playback start frame when the transcoding control unit determines that the video stream received from said streaming server has reached the playback start position,
a video stream transcoding unit that transcodes and outputs the video stream when the transcoding control unit determines that a frame after the playback start frame is required to be transcoded, and
a feed-through output unit that outputs the video stream without any change when said transcoding control unit determines that a frame after the playback start frame is not required to be transcoded.

4. The video streaming system according to claim 2, characterized in that the control information analysis unit comprises a playback start position specifying unit that receives, from the terminal, information that directly designates a playback start position of the video stream, and specifies the playback start position.

5. The video streaming system according to claim 2, characterized in that said control information analysis unit comprises
a reception unit that receives, from the terminal, information that roughly designates a playback start position of the video stream,
a management unit that manages playback history information of video streams for each video stream and for each terminal, and
a search unit that specifies the playback start position by searching for the playback history information on the basis of rough information of the playback start position.

6. The video streaming system according to claim 1, characterized in that
said transcoding device comprises a video stream designation information transmission unit that transmits, to said streaming server, video stream designation information that designates a video stream desired by the terminal and a playback start position of the video stream, and
said streaming server comprises a streaming control unit that starts to transmit the video stream from an intra-frame prediction frame before the playback start position designated by the video stream designation information.

7. The video streaming system according to claim 1, characterized in that said transcoding device further comprises a query unit that, when the terminal selects at least one video stream by using a DTMF signal, transmits, to the terminal, a stream on which at least one piece of information of image information, audio information, and text information that prompts to select a video stream is recorded, by using the DTMF signal.

8. The video streaming system according to claim 1, characterized in that a network that connects said transcoding device to the terminal comprises a circuit switched network.

9. The video streaming system according to claim 1, characterized in that a network that connects said transcoding device to the terminal comprises a packet switched network.

10. The video streaming system according to claim 1, characterized in that a network that connects said transcoding device to the terminal comprises a network including both a packet switched network and a circuit switched network.

11. The video streaming system according to claim 1, characterized in that said transcoding device further comprises advertisement streaming unit that, when at least one video stream desired by the terminal is to be transmitted, transmits a stream on which at least one piece of information of image information, audio information, and text information that represents one of a propaganda and an advertisement is recorded before or after the video stream.

12. The video streaming system according to claim 1, characterized in that
a network that connects said transcoding device to the terminal comprises one of a packet switched network and a network including both a packet switched network and a circuit switched network, and
said transcoding device transmits a video stream to the packet switched network by one of unicasting and multicasting.

13. The video streaming system according to claim 2, characterized in that the video transcoder further comprises a transcoding unit that, when the transcoding control unit determines that a parameter of a frame after the playback start frame is required to be transcoded, transcodes the parameter.

14. A transcoding device characterized by comprising:
a first transmission/reception unit that receives a video stream desired by a terminal from a streaming server; and
a video transcoder that analyzes a received video stream to covert only a portion of the video stream that falls within a range in which transcoding is required, when transmitting the video stream upon transcoding the video stream into a video stream that is configured to be transmitted from an arbitrary position designated by the terminal.

15. The transcoding device according to claim 14, characterized by further comprising
a control information analysis unit that specifies a video stream desired by the terminal and a playback start position of the video stream, and
a second transmission/reception unit that transmits a video stream output from the video transcoder to the terminal, wherein
said video transcoder operates, when transmitting the video stream received from said streaming server from the playback start position.

16. The transcoding device according to claim 15, characterized in that said control information analysis unit comprises a video stream designation information transmission unit that transmits, to said streaming server, a video stream desired by the terminal and video stream designation information that designates a playback start position of the video stream.

17. The transcoding device according to claim 15, characterized in that said control information analysis unit comprises a query unit that, when the terminal selects at least one video stream by using a DTMF signal, transmits, to the terminal, a stream on which at least one piece of information of image information, audio information, and text information that prompts to select a video stream is recorded, by using the DTMF signal.

18. The transcoding device according to claim 14, characterized by further comprising advertisement streaming unit that, when at least one video stream desired by the terminal is to be transmitted, transmits a stream on which at least one piece of information of image information, audio information, and text information that represents one of a propaganda and an advertisement is recorded before or after the video stream.

19. A video streaming method characterized by comprising:
the reception step of receiving a video stream desired by a terminal from a streaming server that stores a video stream; and
the transcoding step of transmitting, to the terminal via a network, a video stream received from the streaming server upon transcoding the video stream into a video stream that is configured to be transmitted from an arbitrary position designated by the terminal,
the transcoding step including the step of analyzing the video stream received from the streaming server to covert only a portion of the video stream that falls within a range in which transcoding is required, when transmitting the video stream upon transcoding the video stream into a video stream that is configured to be transmitted from an arbitrary position designated by the terminal.

20. A video streaming system characterized by comprising:
a streaming server that stores a video stream; and
a transcoding device that transmits, to a terminal via a network, a video stream received from said streaming server upon transcoding the video stream into a video stream that is configured to be transmitted from an arbitrary position designated by the terminal,
said transcoding device comprising means for receiving a video stream desired by the terminal from said streaming server, and analyzing the video stream to covert only a portion of the video stream that falls within a range in which transcoding is required, when transmitting the video stream to the terminal upon transcoding the video stream into a video stream that is configured to be transmitted from an arbitrary position designated by the terminal.

21. A transcoding device characterized by comprising:
means for receiving a video stream desired by a terminal from a streaming server; and
means for analyzing a received video stream to covert only a portion of the video stream that falls within a range in which transcoding is required, when transmitting the video stream upon transcoding the video stream into a video stream that is configured to be transmitted from an arbitrary position designated by the terminal.
